(19) United States
(12) Patent Application Publication
(10) Pub. No.: US 2023/0082356 A1
(43) Pub. Date: Mar. 16, 2023

(54) TRASH CONTAINER WITH FOOTHOLDS

(71) Applicant: Luis Crespo, Live Oak, TX (US)

(72) Inventor: Luis Crespo, Live Oak, TX (US)

(21) Appl. No.: 17/473,000

(22) Filed: Sep. 13, 2021

(51) Int. Cl. B65F 1/06; B65F 1/16

(52) U.S. Cl. CPC B65F 1/068; B65F 1/1646; B65F 2210/168; B65F 2210/178

(57) ABSTRACT

The trash container with footholds disclosed herein may comprise a trash receptacle having positions for a user to stand upon, using their body weight to secure the trash can to the floor so that a trash bag may easily be lifted from the container. The trash container with footholds may further comprise an antimicrobial layer or an antimicrobial material of construction, and may implement a number of features and technologies already known in the industry such as, for example, a step-actuated lid or a sensor-activated lid and a plurality of modern electronic and smart implements.

### TECHNICAL FIELD OF THE INVENTION

The present invention relates in general to trash receptacles, and, more specifically, to a trash container with footholds.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Garbage, trash, or refuse is that waste material discarded by humans due to a lack of perceived utility. The term generally does not include bodily waste products, or liquid, gaseous, or toxic wastes, but instead focuses on those goods that humans generally use in their everyday lives and intend to discard. Garbage may be stored temporarily in appropriate containers until it is collected and hauled away by relevant service providers.

The types of containers usually used for containing trash and, more commonly, recyclable materials generally include trash cans, trash containers, and trash dumpsters. A user, once committed to disposing of their trash, or their recycling, simply deposits the unwanted product into an appropriate container. Such containers, especially those used in the home or in commercial spaces, often are lined with an appropriate liner, such as a plastic trash bag, to facilitate the collection and disposal process.

By way of example, a user may place a trash bag or trash liner into a trash can, and then may place trash into the trash can over a period of time until the trash can or the trash bag are at capacity. The user may then pull the trash bag from the trash can, close the trash bag, and then dispose of the trash bag and its accumulated contents into a dumpster or other receiver for collection by a waste management service.

Often, though, a user of a trash can may find that the over-filled trash bag is not easy to remove from the trash can. By way of example, a trash can that is not mounted to a floor or cabinet may lift off the ground when an over-filled trash bag is lifted from within. By way of another example, a trash bag pulled from a trash can mounted to a floor or cabinet and having a trash liner may pull the trash liner and the trash bag from the trash can. Various solutions exist to remedy this problem, such as separately attaching a trash liner to a trash can or otherwise securing the trash can to the ground so that the trash bag may be lifted out, but these solutions are secondary fixes to these known issues.

Thus, there is a need in the art for a trash container with footholds that may comprise a trash receptacle having positions for a user to stand upon, using their body weight to secure the trash can to the floor so that a trash bag may easily be lifted from the container. The trash container with footholds may further comprise an antimicrobial layer or an antimicrobial material of construction, and may implement a number of features and technologies already known in the industry. It is to these ends that the present invention has been developed.

### BRIEF SUMMARY OF THE INVENTION

To minimize the limitations in the prior art, and to minimize other limitations that will be apparent upon reading and understanding the present specification, the present invention describes a trash container with footholds.

It is an objective of the present invention to provide a trash container with footholds that may comprise a main body.

It is another objective of the present invention to provide a trash container with footholds that may comprise a container base.

It is another objective of the present invention to provide a trash container with footholds that may comprise a container cover.

It is another objective of the present invention to provide a trash container with footholds that may comprise a lid.

It is another objective of the present invention to provide a trash container with footholds that may comprise a hinged lid

It is another objective of the present invention to provide a trash container with footholds that may comprise a plurality of footholds.

It is another objective of the present invention to provide a trash container with footholds that may comprise a cylindrical main body.

It is another objective of the present invention to provide a trash container with footholds that may comprise a rectangular main body.

It is another objective of the present invention to provide a trash container with footholds that may comprise a plurality of sensors.

It is another objective of the present invention to provide a trash container with footholds that may comprise an automatic lid.

It is another objective of the present invention to provide a trash container with footholds that may comprise a non-slip base.

It is another objective of the present invention to provide a trash container with footholds that may comprise an insulating layer.

It is another objective of the present invention to provide a trash container with footholds that may comprise an airtight seal.

It is another objective of the present invention to provide a trash container with footholds that may comprise a resilient material of construction.

It is another objective of the present invention to provide a trash container with footholds that may comprise a water-proof material of construction.

It is another objective of the present invention to provide a trash container with footholds that may comprise a reusable material of construction.

It is another objective of the present invention to provide a trash container with footholds that may comprise an antimicrobial layer.

It is another objective of the present invention to provide a trash container with footholds that may comprise an antimicrobial material of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is an isometric perspective view of a trash container with footholds, as contemplated by the present disclosure;

FIG. 2 is a front plan view of a trash container with footholds, as contemplated by the present disclosure;

FIG. 3 is a rear plan view of a trash container with footholds, as contemplated by the present disclosure;

FIG. 4 is a left side elevation view of a trash container with footholds, as contemplated by the present disclosure;

FIG. 5 is a right side elevation view of a trash container with footholds, as contemplated by the present disclosure;

FIG. 6 is a top plan view of a trash container with footholds, as contemplated by the present disclosure; and

FIG. 7 is a bottom plan view of a trash container with footholds, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The trash container with footholds disclosed herein may comprise a trash receptacle having positions for a user to stand upon, using their body weight to secure the trash can to the floor so that a trash bag may easily be lifted from the container. The trash container with footholds may further comprise an antimicrobial layer or an antimicrobial material of construction, and may implement a number of features and technologies already known in the industry such as, for example, a step-actuated lid or a sensor-activated lid and a plurality of modern electronic and smart implements.

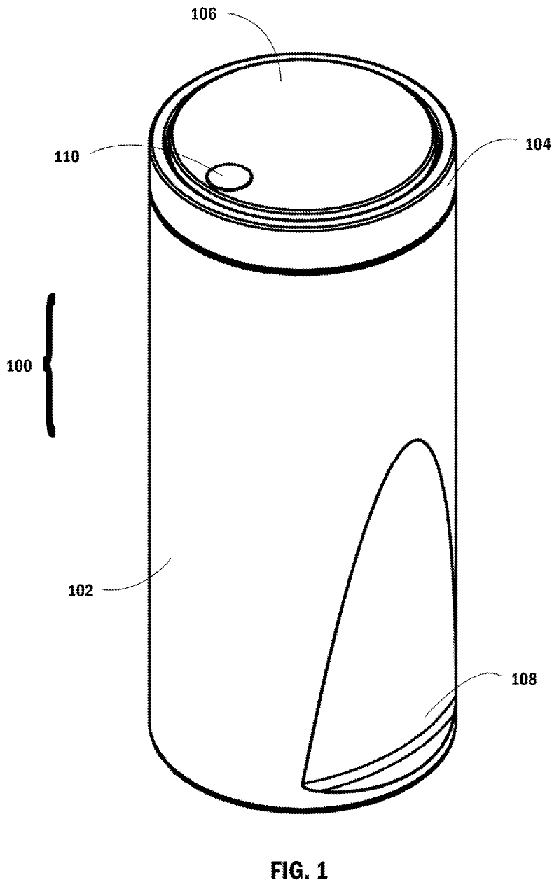

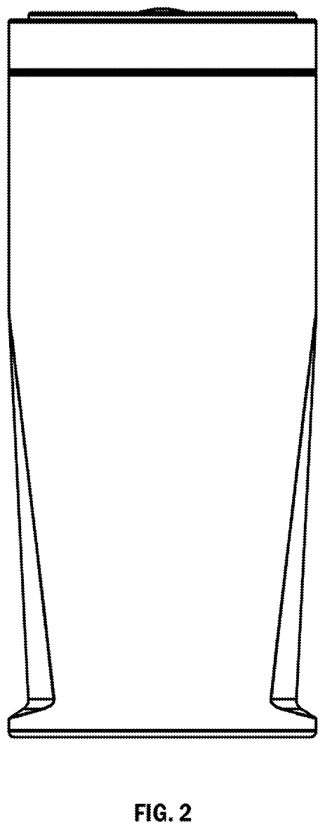

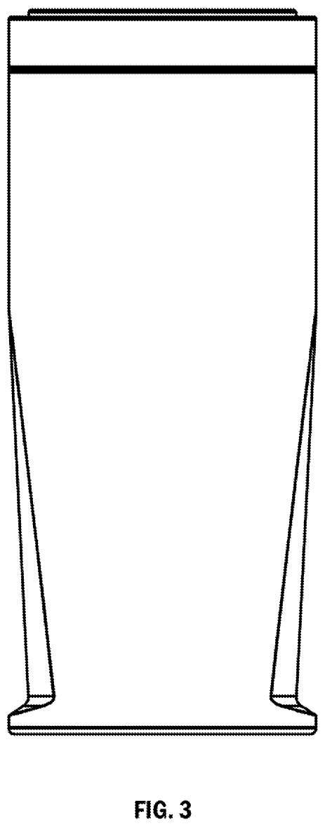

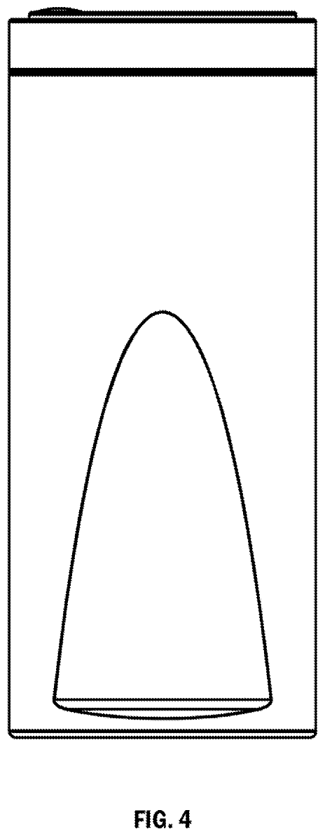

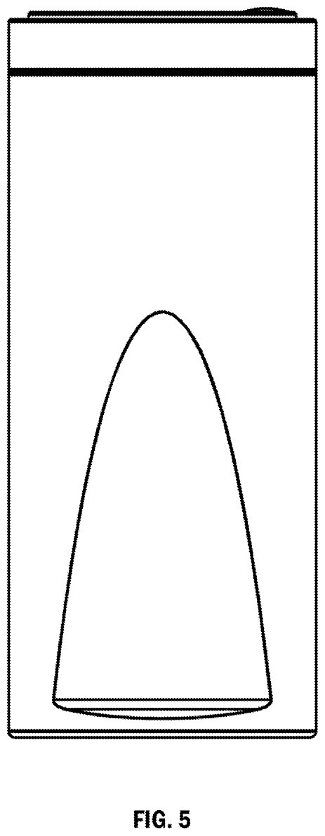

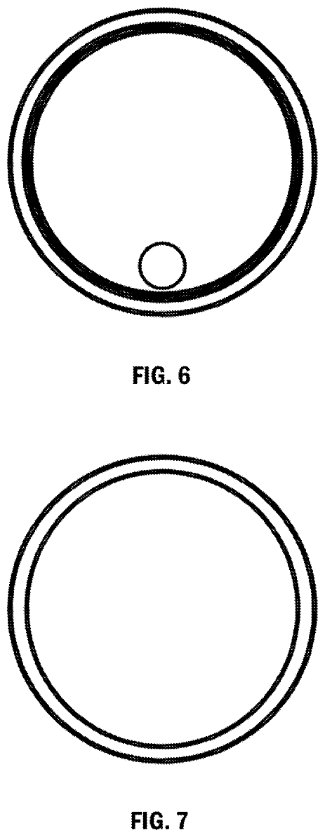

The illustrations of FIGS. 1-7 illustrate a trash container with footholds, as contemplated by the present disclosure. The device may comprise, generally, a main body 100 comprising a base 102, a cover 104, a lid 106, and a plurality of steps 108.

The base 102 of the main body 100 may comprise any shape appropriate to a trash container such as, for example, a cylindrical or rectangular container that may vary as desired in height, length and width, or circumference and may further comprise an internal cavity. The cover 104 of the main body 100 may comprise any shape appropriate to the shape of the base 102 of a particular embodiment such that the cover 104 may sit snugly on top of the base 102. By way of example, a base 102 having a substantially circular cross-section would be matched with a cover 104 having an identical substantially circular cross-section.

In one embodiment the cover 104 may comprise a hinged cover attached to the base 102 by a hinge mechanism. By this design the cover 104 may articulate relative to the base 102. In another embodiment the cover 104 may further comprise a lid 106, which may further comprise a hinged lid attached to the cover 104 by a hinge mechanism. By this design the cover 104 may sit flush on top of the base 102, and the lid 106 may articulate relative to the cover 104. In any embodiment the base 102 further comprises an internal cavity such that a trash bag may be placed into the base 102 to receive waste products.

The base 102 may further comprise a plurality of steps 108, which may comprise two steps placed parallel to each other on opposite sides of the base 102. The plurality of steps 108 may comprise any appropriate shape or design that may facilitate a user standing on both steps simultaneously while also lifting a trash bag from the main body 100. By way of example, the plurality of steps 108 may comprise a left step and a right step projecting out from a bottom surface of the base 102, or may comprise a left step and a right step molded into a left side and a right side, respectively, of the base 102. By this design a user may lift a trash bag from the base 102 while keeping the main body 100 secured to the floor by virtue of the user's weight.

The trash container with footholds disclosed herein may further comprise a number of electronic and smart features known in the industry. By way of example, the lid 106 may further comprise a sensor 110 which may cause the lid to automatically open when a user is detected nearby. By way of another example, the base 102 may further comprise a step onto which a user may apply press to open the lid 106. The base 102 may further comprise a foot pad or a plurality of non-slip feet attached to its bottom surface to provide additional traction for the main body 100.

The main body 100 may further comprise a plurality of layers adhered to one another to provide additional features and characteristics to the main body 100. In one embodiment the main body 100 may further comprise an outer traction layer, which may be a layer comprising some texture or other grip-enhancing features, to improve a user's ability to grip the device. In another embodiment the main body 100 may further comprise an inner insulating layer, which may be a layer comprising some insulating material, to reduce the effect of smells or fluids emanating from the device.

To begin making the trash container with footholds an appropriate machine or device may stamp out sheets of main body 100, perhaps cut from a larger sheet of material, and then an appropriate machine or device may mold or fold the main body 100, perhaps by the use of a formed mold or injection mold. The forming of the main body 100 may be made by any appropriate physical means such as, for example, heating, welding, gluing, riveting or any other similar mechanism.

To begin using the device a user may remove the cover 104 from the base 102 and placed a trash bag within the internal cavity of the base 102. The user may then replace the cover 104 and use the trash container with footholds to receive trash or recycling products over time. Once the trash bag is full the user may then remove the cover 104 from the base 102 and place its feet on the plurality of steps 108 while simultaneously lifting the trash bag out of the internal cavity of the base 102. By this mechanism the base 102 will remain in place due to the user's applied weight while the trash bag is removed. The user may then replace the trash bag and begin the cycle anew.

The trash container with footholds may be substantially constructed of any suitable material or combination of materials, but typically is constructed of a resilient material or combination of materials such that the device is easily manufactured, insulating, and reusable. As an example, and without limiting the scope of the present invention, various exemplary embodiments of the trash container with footholds may be substantially constructed of one or more materials of plastic, acrylic, polycarbonate, fabric, steel, aluminum, brass, fiberglass, carbon fiber, or combinations thereof. In some embodiments the various components of the device may be coated, lined, or otherwise insulated to prevent contamination of the device.

In one embodiment the trash container with footholds may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A trash container with footholds, comprising:
a base;
a cover; and
a plurality of steps;
wherein said base further comprises a bottom surface, a lateral surface, an upper edge, and an internal cavity;
wherein said cover further comprises a bottom edge, a lateral surface, and an upper surface;
wherein said bottom edge of said cover is reversibly attached to said upper edge of said base;
wherein one of said plurality of steps is attached to a left side of said lateral surface of said base; and
wherein one of said plurality of steps is attached to a right side of said lateral surface of said base.

2. The trash container of claim 1, further comprising:
a lid;
wherein said lid comprises said upper surface of said cover.

3. The trash container of claim 2,
wherein said lid further comprises a hinged lid.

4. The trash container of claim 3, further comprising:
a proximity sensor.

5. The trash container of claim 3, further comprising:
a lid-opening step.

6. The trash container of claim 3,
wherein said main body comprises a resilient material of construction.

7. The trash container of claim 3, further comprising:
an antimicrobial layer.

8. The trash container of claim 3, further comprising:
an antimicrobial material of construction.

9. The trash container of claim 3, further comprising:
a plurality of non-slip feet.

10. The trash container of claim 3, further comprising:
a foot pad.
